(19) United States
(12) Patent Application Publication
(10) Pub. No.: US 2021/0329140 A1
(43) Pub. Date: Oct. 21, 2021

(54) IMAGE FORMING APPARATUS

(71) Applicant: KONICA MINOLTA, INC., Tokyo (JP)

(72) Inventor: Takashi TSUCHIYA, Tokyo (JP)

(73) Assignee: KONICA MINOLTA, INC., Tokyo (JP)

(21) Appl. No.: 17/219,767

(22) Filed: Mar. 31, 2021

(30) Foreign Application Priority Data
Apr. 20, 2020 (JP) 2020-074932

(51) Int. Cl. H04N 1/00; H04N 1/21

(52) U.S. Cl. CPC H04N 1/00766; H04N 1/00689; H04N 1/2166

(57) ABSTRACT

When image data is stored in a storing device, the writing speed of the image data is avoided from being lowered. An image forming apparatus is provided with a scanner section that reads a sheet, a storing section that stores image data read by the scanner section, and a controlling section that controls the reading by the scanner section and the storing in the storing section. The controlling section issues, to the storing section, a clear command erasing the stored data with respect to the data storage region of the storing section before the reading by the scanner section at the time of executing a job using the scanner section, so that the clearing operation during the writing operation of the image data is not performed.

### CROSS-REFERENCE TO RELATED APPLICATIONS

The entire disclosure of Japanese Patent Application No. 2020-74932, filed on Apr. 20, 2020, is incorporated herein by reference in its entirety.

### BACKGROUND

### Technological Field

The present invention relates to an image forming apparatus. More specifically, the present invention relates to a technology applied to an image forming apparatus provided with a storing section.

### Description of the Related Art

An image forming apparatus, such as a digital copying machine, is advancing in terms of higher speed, higher resolution, and colorization to dramatically increase the data amount of image data handled. The image forming apparatus typically has a method of storing the image data in a storing device, such as an HDD (Hard Disk Drive) and an SSD (Solid State Drive), which has a large capacity and is relatively inexpensive in terms of bit unit price.

Patent Literature 1 (Japanese Unexamined Patent Application Publication No. 2009-118286) describes a technology in which the image data is compressed and is stored in the HDD of the image forming apparatus, and the compression ratio of the image data is changed according to the data amount of the image data.

### CITATION LIST

### Patent Literature

Patent Literature 1: Japanese Unexamined Patent Application Publication No. 2009-118286

### SUMMARY

There is a problem that in the image forming apparatus, when the size of the image data stored becomes large, the writing frequency becomes too high with respect to the data processing in the storing device, so that the writing speed of the image data becomes low. The lowered writing speed temporarily stops the reading operation until the completion of the writing into the storing device, for example, in continuously reading a plurality of documents, resulting in lowering the number of sheets processed per unit time in the image forming apparatus.

Here, for example, as described in Patent Literature 1 (Japanese Unexamined Patent Application Publication No. 2009-118286), it has been known that when the data amount of the image data is large, the compression ratio of the image data is increased to prevent the data amount stored in the storing device from becoming large. However, increasing the compression ratio of the image data leads to the lowering of the image quality of the image printed onto the sheet and the like, thereby causing a quality problem.

An object of the present invention is to provide an image forming apparatus in which when image data is stored in a storing device, the writing speed of the image data can be avoided from being lowered.

An image forming apparatus of the present invention is provided with a scanner section that reads a sheet, a storing section that stores image data read by the scanner section, and a controlling section that controls the reading by the scanner section and the storing in the storing section and issues, to the storing section, a clear command erasing the stored data with respect to the data storage region of the storing section before the reading by the scanner section at the time of executing a job using the scanner section.

According to the present invention, the clear command is issued to the storing section before the scanner section performs the reading operation for the sheet, thereby securing the region in which the image data is stored, so that the clearing operation of securing the storage region while the scanner section executes the reading operation becomes unnecessary. Therefore, while the scanner section performs the reading operation for the sheet, the reading operation is not temporarily stopped for the clearing operation, so that the job including the reading operation for the sheet is smoothly executed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating the internal configuration of an image forming apparatus according to an embodiment of the present invention;

FIG. 2 is a block diagram illustrating the data processing configuration of the image forming apparatus according to the embodiment of the present invention;

FIG. 3 is a block diagram illustrating the outline of the processing of image data of the image forming apparatus according to the embodiment of the present invention; and

FIG. 4 is a flowchart illustrating the flow of the processing at the time of executing a job in the image forming apparatus according to the embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. Hereinafter, an embodiment (hereinafter, referred to as “this example”) of the present invention will be described with reference to the accompanying drawings.

The Configuration of an Image Forming Apparatus

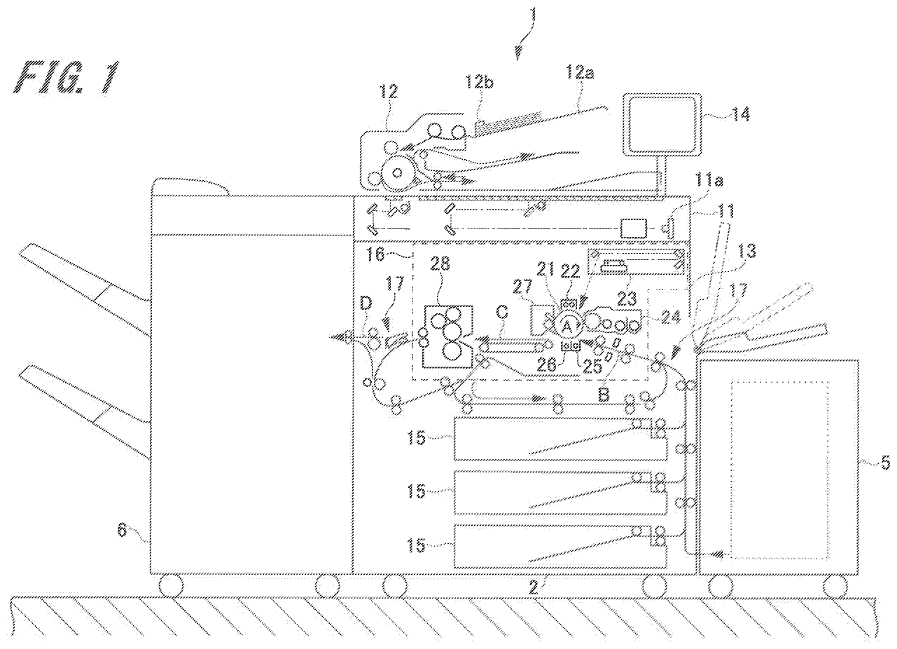

FIG. 1 illustrates the internal configuration of an image forming apparatus 1 of this example.

The image forming apparatus 1 is configured of an image forming apparatus main body 2, a large capacity sheet feeding device 5, and a post-processing device 6 connected at the subsequent stage of the image forming apparatus main body 2. The image forming apparatus 1 is an apparatus called a so-called digital copying machine that is provided with a copying function that optically reads a document and forms its reproduction image on a sheet, a printing function that receives printing data from an external device, such as a personal computer, and forms a corresponding image on the sheet to output the sheet, and the like.

The image forming apparatus main body 2 is provided with a scanner section 11 that reads the sheet of the image of the document, an automatic document feeding device 12 that feeds, one by one, documents placed on a document tray 12a to the document reading position of the scanner section 11, a printer section 13 that forms the image on the sheet to output the sheet, and an operation displaying section 14.

The scanner section 11 is a reading section that inputs the image on the sheet, and has a function as an image inputting section. That is, the scanner section 11 is configured of a light source that emits light onto the document, a line image sensor 11a that reads the document for one line in its width direction, an optical path including a lens or a mirror that guides the reflection light from the document to the line image sensor 11a for focusing, and the like.

The scanner section 11 performs the so-called scanning type reading processing that reads the document while relatively moving the document with respect to the reading position by conveying the document by the automatic document feeding device 12. Further, the scanner section 11 can also read the document placed on a platen glass. It should be noted that a sheet detecting section 12b that detects the size and the quantity (the number) of the sheets (documents) placed on the document tray 12a is mounted on the automatic document feeding device 12. The information of the size and the number of sheets detected by the sheet detecting section 12b is sent to an image control CPU 47 described later.

The printer section 13 is configured of a plurality of sheet feed trays 15 for accommodating each sheet for image formation, an image forming section 16 that forms the image on the sheet, and a sheet conveying mechanism 17. The sheet conveying mechanism 17 feeds the sheet from the large capacity sheet feeding device 5 or each of the sheet feed trays 15, passes the sheet through the image forming section 16, and ejects the sheet to the post-processing device 6 at the subsequent stage.

The image forming section 16 is configured of a photoconductor 21, an electrifying device 22, a laser unit 23, a developing device 24, a transferring device 25, a separating device 26, a cleaning device 27, a fixing device 28, and the like, and forms the image on the sheet by the electrophotographic process.

The photoconductor 21 has a cylindrical shape, and is rotated in the constant direction (the arrow A direction in the drawing) by a driving section, not illustrated. During the rotation, the photoconductor 21 is uniformly electrified by the corona discharge by the electrifying device 22, and then receives the scanning of the laser beam turned on and off according to the image data from the laser unit 23, so that an electrostatic latent image is formed on its surface. The developing device 24 visualizes, as a toner image, the electrostatic latent image formed on the surface of the photoconductor 21.

The sheet conveying mechanism 17 feeds and conveys the sheet from the large capacity sheet feeding device 5 or the sheet feed tray 15, and sends the sheet into between the photoconductor 21 and the transferring device 25 at the suitable timing (the arrow B). The transferring device 25 electrostatically transfers the toner image formed on the surface of the photoconductor 21 onto the sheet conveyed by the sheet conveying mechanism 17. The separating device 26 separates the sheet from the photoconductor 21. The cleaning device 27 scrubs and removes the toner remaining on the photoconductor 21 after the transfer by a blade and the like. The sheet onto which the toner image is transferred is further conveyed (the arrow C), is pressurized and heated while passing through the fixing device 28, to fix the toner image onto the sheet, and is then ejected to the post-processing device 6 (the arrow D).

The post-processing device 6 has a function of bundling a plurality of sheets and binding the bundled sheets with a staple, a function of opening a hole by a punch, and the like. It should be noted that the image forming section 16 may form the image on the sheet by other methods other than the electrophotographic method.

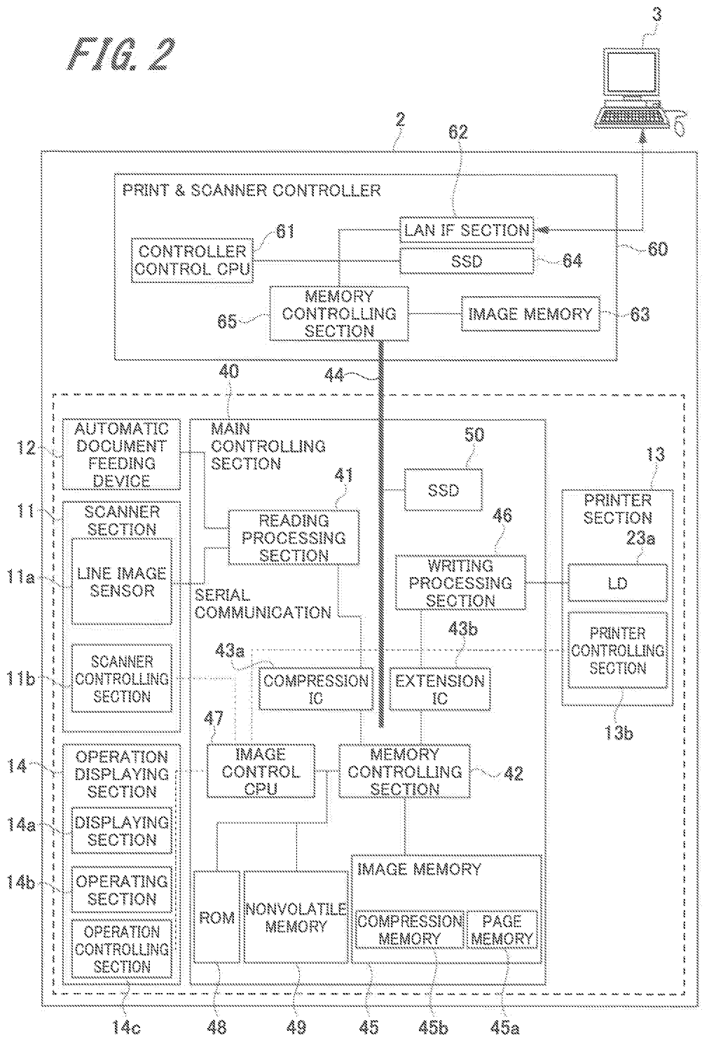

FIG. 2 is a block diagram illustrating the data processing configuration of the image forming apparatus main body 2.

The image forming apparatus main body 2 is configured by connecting the scanner section 11, the printer section 13, the operation displaying section 14, and an image processing section 60 to a main controlling section 40 that performs the overall control of the operation of the image forming apparatus main body 2.

The scanner section 11 is provided with a scanner controlling section 11b that controls the entire operation of the scanner section 11 besides the line image sensor illustrated in FIG. 1. The printer section 13 has a laser diode (LD) 23a that is turned on and off according to the image data, a printer controlling section 13b that controls the operation of the entire printer section 13 including the image forming section 16, the sheet conveying mechanism 17, and the like, and the like. In addition, a motor, a solenoid, a sensor, and the like that operate the respective portions of the image forming section 16 and the sheet conveying mechanism 17 are connected to the printer controlling section 13b.

The operation displaying section 14 has a function of displaying various setting screens and operation screens and receiving various setting/selection operations from the user, and has a function of displaying various information and alerts toward the user. The operation displaying section 14 has a displaying section 14a including a liquid crystal display, an operating section 14b that includes a touch sensor and various switches disposed on its screen, and an operation controlling section 14c that controls the displaying section 14a and the operating section 14b.

It should be noted that the scanner controlling section 11b, the operation controlling section 14c, and the printer controlling section 13b are each configured of a circuit in which a CPU (Central Processing Unit), a ROM (Read Only Memory), and a RAM (Random Access Memory) are main portions, and execute various controls according to the program stored in the ROM.

The main controlling section 40 has a function of performing the overall control of the operation of the image forming apparatus 1, and is provided with a reading processing section 41, a memory controlling section 42, a compression IC 43a, an extension IC 43b, an image memory (semiconductor memory) 45, a writing processing section 46, the image control CPU 47, a ROM 48, a nonvolatile memory 49, and an SSD (large capacity storing section) 50.

The reading processing section 41 subjects the image data outputted by the scanner section 11 to the expanding processing, the mirror image processing, the binarizing processing by error diffusion, and the like. The compression IC 43a compresses the image data, and the extension IC 43b extends the compressed image data (compression image data) to the original image data. The compression method of the compression IC 43a may be JPEG (Joint Photographic Experts Group) and the like, or its own method. The image memory 45 is used as a page memory 45a that can store the non-compression image data in each page and a compression memory 45b that stores the compression image data.

The writing processing section 46 outputs the signal for turning on and off the laser diode 23a of the laser unit 23 according to the image data read from the compression memory 45b and extended, to the laser diode 23a at the timing according to the operation of the printer section 13. The memory controlling section 42 performs the timing control of the read/write and refresh with respect to the image memory 45 including a dynamic RAM, the timing control when the image data is compressed to be stored in the compression memory 45b or the compression image data is read from the compression memory 45b to be extended, and the like.

The image control CPU 47 is a CPU that controls the entire operation of the image forming apparatus main body 2, controls the processing of the image data, and manages the reservation registration of a job and the execution of the job. The image control CPU 47 is operated according to the program stored in the ROM 48. User data, system data, and the like to be stored after the power supply is turned off are stored in the nonvolatile memory 49.

A PCI (Peripheral Component Interconnect) bus 4 is connected to the memory controlling section 42, and the SSD 50 is connected to a PCI bus 44. The SSD 50 is a nonvolatile storing device that has a large capacity and enables rewriting, and has a lower data reading/writing speed (transferring speed or accessing speed) than the image memory 45. The compression image data, the setting information of the job, and the like that are transferred from the compression memory 45b are stored in the SSD 50. The writing (storing) and the reading of the image data and the like into/from the SSD 50 are executed by the instruction from the image control CPU 47.

It should be noted that although the example in which the SSD is used as the large capacity storing device is illustrated in FIG. 2, other storing device, such as an HDD, may be used in place of the SSD 50.

The image processing section 60 is further connected to the PCI bus 44. The image processing section 60 has a function as a print controller that receives the printing data from an external terminal 3, such as the personal computer, and develops the printing data to raster image data. Also, the image processing section 60 has a function as a scanner controller that transmits the image data acquired by reading the document by the scanner section 11 through a network to the external terminal 3 and the like by an e-mail or FTP (File Transfer Protocol).

The image forming apparatus 1 can handle the image data in which the image data acquired by developing the printing data to the raster image data is received through the network by the image processing section 60, like the image data read by the scanner section 11 and acquired. Therefore, the image processing section 60 has a function as an inputting section that inputs the image data.

The image processing section 60 is provided with a controller control CPU 61 that performs the overall control of the function that the image forming apparatus 1 has, and a LAN IF section 62 that serves as a communicating function for connection to a LAN (Local Area Network). Also, the image processing section 60 is provided with an image memory 63 and an SSD 64 that perform the accumulation of the image data and the like, and a memory controlling section 65 that controls these. The memory controlling section 65 performs the timing control of the read/write and refresh with respect to the image memory 63 that includes a dynamic RAM. Also, the memory controlling section 65 performs the exchange of the image data and the like with the memory controlling section 42 of the main controlling section 40 through the PCI bus 44.

The Outline of the Processing of the Read Image Data

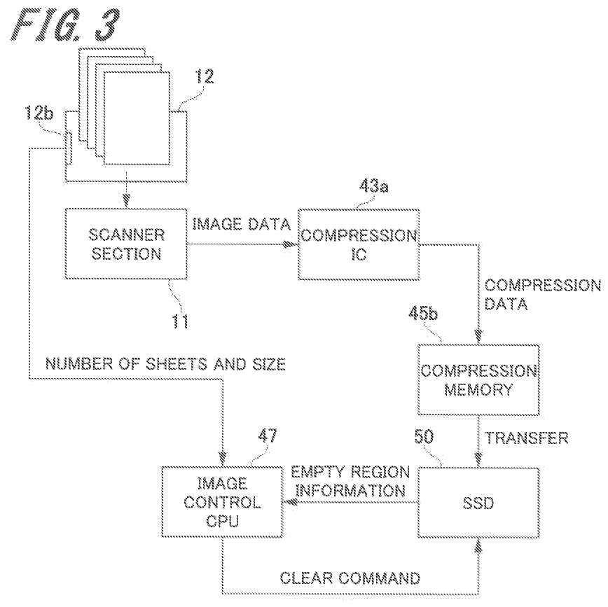

FIG. 3 illustrates the outline of the processing in which the documents loaded in the automatic document feeding device 12 of the image forming apparatus 1 are read and are stored in the SSD 50 that is the storing section.

Documents loaded in the automatic document feeding device 12 are read one by one by the scanner section 11 to be made into the image data. It should be noted that the size and the number (quantity) of sheets of the documents loaded in the automatic document feeding device 12 are detected by the sheet detecting section 12b mounted on the automatic document feeding device 12, and are then sent to the image control CPU 47. However, the number of sheets detected by the sheet detecting section 12b is the estimation value acquired from the measurement value of the thickness of all the documents.

The image data acquired by the scanner section 11 is supplied to the compression IC 43a via the reading processing section 41 (FIG. 2), and is converted to the compressed image data (compression data).

The compression data converted by the compression IC 43a is once stored in the compression memory 45b in the image memory 45 by the control of the memory controlling section 42.

Further, the compression data stored in the compression memory 45b is transferred to and stored in the SSD 50. When the compression data is stored in the SSD 50, the image control CPU 47 confirms the empty region of the SSD 50 at the start of the reading job by the scanner section 11, and transmits a clear command that secures the confirmed empty region as the region for writing the compression data.

That is, when the reading job by the scanner section 11 is started, the image control CPU 47 confirms the size and the number of sheets of the documents detected by the sheet detecting section 12b of the automatic document feeding device 12. Then, the image control CPU 47 estimates the data amount of the compression data from the confirmed size and the confirmed number of sheets of the documents, confirms the empty region of the SSD 50, and confirms whether the estimated data amount has been secured as the empty region. Here, when the estimated data amount has been secured as the empty region, the image control CPU 47 transmits, to the SSD 50, the clear command for securing the region into which the compression data is written. When the clear command is transmitted to the SSD 50, the information of the region that enables the writing of the data, that is, the region in which the clear command becomes effective, is added.

The SSD 50 to which the clear command is transmitted secures the designated region as the region in which the writing of the data is newly enabled. Thus, the compression data in which all the image data read by the reading job by the scanner section 11 are converted is written into the secured region of the SSD 50. Therefore, for example, the operation that secures the storage region of the SSD 50 is not performed in the middle of the writing into the SSD 50.

The compression data written into the SSD 50 is read by the control of the image control CPU 47, and for example, when the job at this time is the printing function, the read compression data is extended by the extension IC 43b to be supplied to the printer section 13, and the printing processing is executed. Also, when the job at this time is the data transferring function to the outside, the compression data read from the SSD 50 is transmitted to the external terminal 3 and the like via the LAN IF section 62.

The processing at the time of executing the job in the image forming apparatus

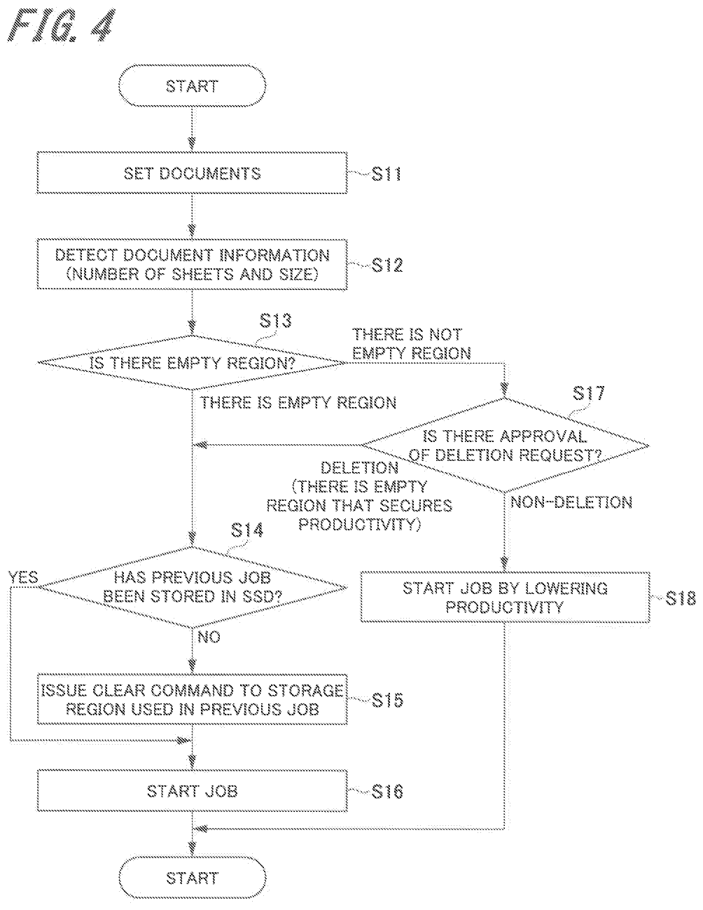

FIG. 4 is a flowchart illustrating the flow of the processing at the time of executing the job using the scanner section 11 of the image forming apparatus 1.

First, when there is the setting of the documents onto the document tray 12a of the automatic document feeding device 12 (step S11), the sheet detecting section 12b of the automatic document feeding device 12 detects the number and the size of the documents (sheets), and the image control CPU 47 acquires the detected document information (step S12). It should be noted that the sheet detecting section 12b detects the size and the quantity (thickness) of the set documents, and estimates the number of sheets from the quantity of the documents.

When the image control CPU 47 acquires the document information, the image control CPU 47 predicts the data amount of the image data (compression data) written into the SSD 50 from the size and the number of sheets of the acquired documents. Then, the image control CPU 47 confirms the current empty region of the SSD 50, and determines whether or not there is the empty region that is equal to or larger than the data size of the predicted writing data (step S13).

When it is determined in step S13 that there is the empty region that is equal to or larger than the data size of the writing data (“there is the empty region” in step S13), the image control CPU 47 determines whether or not the compression data at the time of executing the previous job has been stored in the SSD 50 (step S14).

When in step S14, the compression data at the time of executing the previous job has not been stored in the SSD 50 (NO in step S14), the image control CPU 47 issues the clear command that secures, as the writing region, the storage region of the SSD 50 used at the time of executing the previous job (step S15).

Thereafter, the actual job is started to perform the scanning of the documents set in the automatic document feeding device 12 by the scanner section 11, the writing of the image data (compression data) acquired by the scanning into the SSD 50, and further, the printing of the image data written into the SSD 50, and the like (step S16).

Also, when in step S14, the compression data at the time of executing the previous job has been stored in the SSD 50 (YES in step S14), the issuing of the clear command in step S15 is omitted to shift to the job execution in step S16.

The state where the compression data at the time of executing the previous job has been stored in the SSD 50 corresponds to the case where the setting to cause the SSD 50 to hold the image data after the completion of the job has been performed by the user operation and the like. However, when the issuing of the clear command in step S15 is omitted to shift to the job execution in step S16, since it is confirmed that there is already the necessary empty region in the SSD 50 in step S13, the processing time only takes slightly longer at most as compared with the case where the clear command is issued.

Also, when it is determined in step S13 that there is not the empty region (“there is not the empty region” in step S13), the image control CPU 47 displays, on the displaying section 14a, the instruction of the deletion of the stored data of the SSD 50, and determines whether or not there is the approval of the deletion request by the user operation on the operating section 14b after the display (step S17).

When in step S17, it is determined that there is the approval of the deletion request (“deletion” in step S17), the image control CPU 47 deletes the compression data and the like of the previous job to secure the empty region of the SSD 50, and shifts to the processing in step S14.

Also, when it is determined in step S17 that there is not the approval of the deletion request (“non-deletion” in step S17), the image control CPU 47 starts the job of the scanning or the copying without performing the processing for increasing the empty region of the SSD 50 (step S18). The clear command is not issued in advance at the time of executing the job started in step S18, so that for example, each time each sheet is scanned by the scanner section 11 to acquire the image data, the processing for securing the region in which the compression data of the image data of the each sheet is written into the SSD 50 is performed. Therefore, the execution of the job in step S18 can take a longer time than the execution of the job in step S16, thereby lowering the productivity at the time of executing the job.

As described above, according to the image forming apparatus 1 of this example, when the job, such as the copying, is executed, the clear command is issued to the SSD 50 that is the storing section into which the compression data is previously written at the time of the start of the job, and the writing region is secured to then execute the job, such as the scanning.

For this reason, the processing for securing the writing region in the SSD 50 each time one document is read is not performed during the operation from the reading of the document by the scanner section 11 to the writing of the compression data into the SSD 50. Also, the scanning is continuously and smoothly performed since the image forming apparatus 1 is not temporarily brought into the standby state during the reading of the document. From this, as a result, the reading time of the document can be shortened at the time of executing the job, so that the productivity at the time of executing the job can be improved.

### Modification

It should be noted that the present invention is not limited to the embodiment described above, and modification and change can be made within the scope not departing from the purport of the present invention.

For example, in the processing described in the flowchart in FIG. 4, it is determined in step S13 whether the empty region of the SSD 50 is equal to or larger than the data size of the image data (compression data) written, and whether or not the issuing of the clear command is performed is set. On the other hand, when the usage rate of the SSD 50 that is the storing section is equal to or lower than a predetermined usage rate, the clear command may be unissued, and when the usage rate of the SSD 50 is higher than the predetermined usage rate, the clear command may be issued. The usage rate here is the rate of the storage region in which the stored data that cannot be erased is stored, in the entire storage region of the SSD 50.

For example, when the usage rate is equal to or lower than 50%, the image control CPU 47 does not issue the clear command before the start of the job by assuming that the writing region of the image data can be immediately secured. On the other hand, when the usage rate exceeds 50%, it can take a relatively long time to secure the writing region of the image data during the job execution, so that the clear command is preferably issued before the start of the job.

Also, in the embodiment described above, the image control CPU 47 acquires the document information about the size and the quantity of the set sheets from the sheet detecting section 12b, and estimates the data size of the image data. On the other hand, the image control CPU 47 may estimate the data size of the image data written into the SSD 50 by other processing.

For example, the image control CPU 47 may acquire the information of the average number of sheets and the average size read by one job by the scanner section 11 of the image forming apparatus 1 to estimate the data size of the image data. Alternatively, the image control CPU 47 may store the maximum reading number of sheets in one job within a predetermined period, such as the past one month, to estimate the data size of the image data from the number of sheets.

However, when after these estimations are performed, the continuous scanning that exceeds the data size (the number of sheets) estimated at the time of executing the job is performed, the operation of securing the storage region is performed during the writing into the SSD 50, so that the operation can temporarily become slow.

Alternatively, the image control CPU 47 may estimate the data size of the reading data on the basis of the information set to the job to issue the clear command that secures the estimated region.

For example, when the user performs the operation of starting the execution of the job and there is the setting about the detail of the job, such as the reading number of sheets and the sheet size, the image control CPU 47 estimates the data size of the reading data on the basis of the setting to issue the clear command that secures the estimated region.

Also, in the embodiment described above, although the image control CPU 47 issues the clear command to the SSD 50, other controlling section (for example, the memory controlling section 42) in the image forming apparatus 1 may issue the clear command.

Further, the point that the SSD is used as the storing section that receives the issued clear command is an example, and a storing device including an HDD or other various recording media may be used.

Also, the case where the processing of the embodiment described above is performed by the image forming apparatus 1 can be responded by implementing the program (software) that executes the processing described in the flowchart in FIG. 4 on the image control CPU 47 and the like.

The program and the data in this case can be stored in the recording medium, such as a semiconductor memory and various disks, to be implemented on the image forming apparatus 1.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

1 . . . image forming apparatus, 2 . . . image forming apparatus main body, 3 . . . external terminal, 4 . . . PCI bus, 5 . . . large capacity sheet feeding device, 6 . . . post-processing device, 11 . . . scanner section, 11a . . . line image sensor, 11b . . . scanner controlling section, 12 . . . automatic document feeding device, 12a . . . document tray, 12b . . . sheet detecting section, 13 . . . printer section, 13b . . . printer controlling section, 14 . . . operation displaying section, 14a . . . displaying section, 14b . . . operating section, 14c . . . operation controlling section, 15 . . . sheet feed tray, 16 . . . image forming section, 17 . . . sheet conveying mechanism, 21 . . . photoconductor, 22 . . . electrifying device, 23 . . . laser unit, 23a . . . laser diode, 24 . . . developing device, 25 . . . transferring device, 26 . . . separating device, 27 . . . cleaning device, 28 . . . fixing device, 40 . . . main controlling section, 41 . . . reading processing section, 42 . . . memory controlling section, 44 . . . PCI bus, 45 . . . compression memory, 45 . . . image memory, 45a . . . page memory, 45b compression memory, 46 . . . writing processing section, 47 . . . image control CPU, 48 . . . ROM, 49 . . . nonvolatile memory, 50 . . . SSD, 60 . . . image processing section, 61 . . . controller control CPU, 62 . . . LAN IF section, 63 . . . image memory, 64 . . . SSD, 65 . . . memory controlling section, 43a . . . compression IC, 43b . . . extension IC

1. An image forming apparatus comprising:
a scanner section that reads a sheet;
a storing section that stores image data read by the scanner section; and
a controlling section that controls the reading by the scanner section and the storing in the storing section and issues, to the storing section, a clear command erasing the stored data with respect to the data storage region of the storing section before the reading by the scanner section at the time of executing a job using the scanner section.

2. The image forming apparatus according to claim 1,
wherein the controlling section does not issue the clear command for the data storage region in which the image data read by the job to which the setting to cause the storing section to hold the image data after the completion of the job has been performed is stored.

3. The image forming apparatus according to claim 1,
wherein the controlling section does not issue the clear command when the data size of the image data stored in the storing section is equal to or smaller than a predetermined size, and issues the clear command when the data size of the image data stored in the storing section is larger than the predetermined size.

4. The image forming apparatus according to claim 1,
wherein the controlling section does not issue the clear command when the usage rate of the storing section is equal to or lower than a predetermined usage rate, and issues the clear command when the usage rate of the storing section is higher than the predetermined usage rate.

5. The image forming apparatus according to claim 1,
wherein the controlling section estimates the data size of the image data read by the scanner section, issues the clear command to the region of one portion of the storing section so that the remaining capacity of the storing section becomes a capacity that can store the image data of the estimated data size, and does not issue the clear command to the region of the remaining portion of the storing section.

6. The image forming apparatus according to claim 5,
wherein the scanner section is provided with a sheet detecting section, and
wherein the controlling section estimates the data size of the reading data on the basis of the quantity of sheets detected by the sheet detecting section.

7. The image forming apparatus according to claim 5,
wherein the controlling section estimates the data size of the reading data on the basis of the information set to the job.
